(19) United States
(12) Patent Application Publication
(10) Pub. No.: US 2017/0326631 A1
(43) Pub. Date: Nov. 16, 2017

(54) Unit Cell Titanium Casting

(71) Applicant: Callaway Golf Company, Carlsbad, CA (US)

(72) Inventors: Jan Paraiso, Carlsbad, CA (US); Lowell Wickett, San Marcos, CA (US); Norm Smith, Oceanside, CA (US); Mark Leposky, Carlsbad, CA (US); Dan Marin, Ramona, CA (US)

(73) Assignee: Callaway Golf Company, Carlsbad, CA (US)

(21) Appl. No.: 15/588,493

(22) Filed: May 5, 2017

Related U.S. Application Data
(60) Provisional application No. 62/334,316, filed on May 10, 2016.
(60) Provisional application No. 62/334,944, filed on May 11, 2016.
(60) Provisional application No. 62/335,554, filed on May 12, 2016.

(51) Int. Cl. B22D 18/06; H05B 6/06; B22D 21/00; H05B 6/26; B22D 18/08

(52) U.S. Cl. CPC B22D 18/06; H05B 6/26; B22D 18/08; B22D 21/005; H05B 6/06

(57) ABSTRACT

A system (5) and method (800) for unit cell casting of titanium or titanium-alloys is disclosed herein. The system (5) comprises an external chamber (45), a crucible (10) positioned within the external chamber (45), an induction coil (15) positioned around the crucible, an internal chamber (40) positioned within the external chamber (45), and a mold (30) positioned within the internal chamber (40). The external chamber (45) is evacuated and a pressurized gas is injected into the evacuated external chamber (45) to create a pressurized external chamber (45). An ingot (20) is melted within the crucible utilizing induction heating generated by the induction coil (15). The internal chamber (40) is evacuated to create an evacuated internal chamber (40). The titanium alloy material of the ingot (20) is completely transferred into the mold (30) from the crucible (10) using a pressure differential created between the external chamber (45) and the internal chamber (40).

### CROSS REFERENCES TO RELATED APPLICATIONS

The present application claims priority to U.S. Provisional Patent Application No. 62/334,316, filed on May 10, 2016, U.S. Provisional Patent Application No. 62/334,944, filed on May 11, 2016, and U.S. Provisional Patent Application No. 62/335,554, filed on May 12, 2016, each of which is hereby incorporated by reference in its entirety.

### STATEMENT REGARDING FEDERALLY SPONSORED RESEARCH OR DEVELOPMENT

Not Applicable

### BACKGROUND OF THE INVENTION

### Field of the Invention

The present invention relates to precision titanium casting. More specifically, the present invention relates to an apparatus and method for precision titanium casting utilizing induction heating.

### Description of the Related Art

Various methods of titanium casting are well-known. One such method is investment casting which involves a lost wax procedure.

Vacuum electric arc smelting is another method in which a titanium ingot is melted by substantial heat generated by mutual discharging in a high current state by respectively using a titanium ingot crucible and a water-cooled copper crucible as a positive electrode and a negative electrode, thereby forming a molten liquid metal in the crucible and completing the casting of the titanium.

Another method is vacuum induction smelting in which an induction coil is wrapped outside a split-type water-cooled copper crucible. The electromagnetic force generated by the induction coil passes through a nonmetal isolation portion between splits of the copper crucible and then acts on a titanium ingot placed inside the crucible. Then the molten metal forms a molten metal liquid inside the crucible and the casting of the titanium is completed.

Vacuum induction smelting and vacuum electric arc smelting require the use of a water-cooled copper crucible which results in the loss of substantial heat. The actual power consumed is very little (only 20% to 30% of the power actually acts on the titanium). Furthermore, the preparation of the molding shell is very complex and time consuming, which adds to the costs. In the traditional casting technology, the operation time of a single furnace is usually 60 to 80 minutes, and the loading and discharge process requires the coordination of many people. In the traditional casting technology, the process from the preparation of the wax pattern to the clearing of the molding shell can take ten days.

Titanium is an extremely reactive metal. During melting via traditional casting processes, a water cooling environment is required. The molten titanium liquid will come into direct contact with water if the crucible cracks, resulting in a fierce reaction, or even explosion, which poses a great threat to production safety.

To solve the above problems, a new kind of titanium alloy induction melting vacuum suction casting device is urgently needed, to solve the problems with existing titanium alloy casting, such as low efficiency, high cost, complicated technology, heavy workload, difficulty with preparing high-quality molding shells, long cycle and potential hazard.

### BRIEF SUMMARY OF THE INVENTION

Currently the loading of the pre-heated pattern mold occurs between the pre-heat furnace and the casting furnace. The pattern mold itself is currently affixed to the underside of the top plate of the inner chamber utilizing a forked wedge. The top plate (with mold attached) is then inverted and placed onto the inner chamber body. In order to reduce the time required to load the pattern mold (thus minimizing heat loss) and reduce the chance of pattern mold breakage (due to stress caused by the wedge and/or damage during transportation) a cradle should be utilized to support the mold. The cradle would be created within the inner chamber and be designed specifically to hold and orient the pattern mold. The pattern mold itself would be modified to create a funnel at the top of the main gate to allow material to flow into and fill the mold. The use of this feature will allow for faster/more repeatable cycle times which will minimize part to part variation.

One aspect of the present invention is a method for unit cell casting of titanium or titanium-alloys. The method includes monitoring temperature data of an internal chamber. The method also includes transmitting the temperature data to a programmable logic controller (PLC). The method also includes positioning a mold within the internal chamber. The method includes evacuating an external chamber to create an evacuated external chamber wherein a ceramic crucible containing a titanium alloy ingot is positioned therein. The method also includes injecting a pressurized gas into the evacuated external chamber to create a pressurized external chamber. The method also includes melting the titanium alloy ingot within the ceramic crucible utilizing induction heating generated by an induction coil positioned around the ceramic crucible. The method also includes evacuating the internal chamber to create an evacuated internal chamber, wherein a mold is positioned within the pattern mold cradle within the internal chamber. The method also includes transferring the completely melted titanium alloy material into the mold from the crucible using a pressure differential created between the external chamber and the internal chamber. A frequency generated in the induction coil ranges from 1 kilo-Hertz to 50 kilo-Hertz, and a power ranges from 15 kilo-Watts to 50 kilo-Watts. An atmospheric pressure of the evacuated internal chamber ranges from 3×10⁻² atmosphere to 9.87×10⁻⁷ atmosphere. An atmospheric pressure of the evacuated internal chamber ranges from 9.87×10⁻⁷ atmosphere to 9.87×10⁻¹³ atmosphere.

The method further comprises heating the mold using an infrared heating unit positioned within the internal chamber to create a heated mold. The method further comprises cooling the titanium alloy within the mold.

Another aspect of the present invention is a system for unit cell casting of titanium or titanium-alloys. The system comprises an external chamber, a ceramic crucible positioned within the external chamber, an induction coil positioned around the ceramic crucible, an internal chamber positioned within the external chamber, a mold positioned within the internal chamber, an optical pyrometer positioned within the internal chamber, and a PLC. The temperature of the internal chamber is monitored and communicated to the PLC during the casting process, and the PLC controls the temperature of the internal chamber and the heat generated by the induction coil. The external chamber is evacuated to create an evacuated external chamber wherein the ceramic crucible contains a titanium alloy ingot positioned therein. A pressurized gas is injected into the evacuated external chamber to create a pressurized external chamber. The titanium alloy ingot is melted within the ceramic crucible utilizing induction heating generated by the induction coil positioned around the ceramic crucible. The internal chamber is evacuated to create an evacuated internal chamber. The titanium alloy material is completely transferred into the mold from the crucible using a pressure differential created between the external chamber and the internal chamber.

Another aspect of the present invention is a system for unit cell casting of titanium or titanium-alloys. The system comprises an external chamber, a ceramic crucible positioned within the external chamber, an induction coil positioned around the ceramic crucible, an internal chamber positioned within the external chamber, a mold positioned within the internal chamber, a first vacuum gauge positioned within the internal chamber, a second vacuum gauge positioned within the external chamber, and a PLC in communication with the first vacuum gauge, the second vacuum gauge, and the induction coil. The pressure of the internal chamber and the pressure of the external chamber are monitored and communicated to the PLC during the casting process, and the PLC controls the casting process based on the pressure of the internal chamber and the pressure of the external chamber. The external chamber is evacuated to create an evacuated external chamber wherein the ceramic crucible contains a titanium alloy ingot positioned therein. A pressurized gas is injected into the evacuated external chamber to create a pressurized external chamber. The titanium alloy ingot is melted within the ceramic crucible utilizing induction heating generated by the induction coil positioned around the ceramic crucible. The internal chamber is evacuated to create an evacuated internal chamber. The titanium alloy material is completely transferred into the mold from the crucible using a pressure differential created between the external chamber and the internal chamber.

The pressurized gas is preferably argon. The mold is preferably covered in a kaolin wool insulating material. The mold is preferably for a thin-walled golf club head. The mold is alternatively for an article having a wall thickness less than 0.250 inch. The induction melting time preferably ranges from 30 seconds to 90 seconds. The ceramic crucible is preferably composed of two yttria-based primary crucible layers, wherein a first primary crucible layer has a thickness ranging from 0.010 inch to 0.060 inch, and a second primary crucible layer has a thickness ranging from 0.001 inch to 0.020 inch. The ceramic crucible further comprises a silica based backup layer. The induction coil is preferably positioned around a bottom section of the ceramic crucible. The induction coil is alternatively positioned around an upper section of the ceramic crucible.

Another aspect of the present invention is a method for unit cell casting of titanium or titanium-alloys. The method includes monitoring a pressure of an internal chamber utilizing a first vacuum gauge. The method also includes monitoring a pressure of an external chamber utilizing a second vacuum gauge. The method also includes transmitting the pressure of the internal chamber and the pressure of the external chamber to a programmable logic controller (PLC). The method also includes positioning a mold within the internal chamber. The method also includes evacuating an external chamber to create an evacuated external chamber wherein a ceramic crucible containing a titanium alloy ingot is positioned therein. The method also includes injecting a pressurized gas into the evacuated external chamber to create a pressurized external chamber. The method also includes melting the titanium alloy ingot within the ceramic crucible utilizing induction heating generated by an induction coil positioned around the ceramic crucible. The method also includes evacuating the internal chamber to create an evacuated internal chamber. The method also includes transferring the completely melted titanium alloy material into the mold from the crucible using a pressure differential created between the external chamber and the internal chamber. The pressure of the internal chamber and the pressure of the external chamber are monitored and communicated to the PLC during the casting process, and the PLC controls the casting process based on the pressure of the internal chamber and the pressure of the external chamber.

Another aspect of the present invention is a method for unit cell casting of titanium or titanium-alloys. The method includes monitoring a pressure of an internal chamber utilizing a first vacuum gauge. The method also includes monitoring a pressure of an external chamber utilizing a second vacuum gauge. The method also includes transmitting the pressure of the internal chamber and the pressure of the external chamber to a programmable logic controller (PLC). The method also includes positioning a mold within the internal chamber. The method also includes evacuating an external chamber to create an evacuated external chamber wherein a ceramic crucible containing a titanium alloy ingot is positioned therein. The method also includes injecting a pressurized gas into the evacuated external chamber to create a pressurized external chamber with a pressure in excess of 1 atm. The method also includes melting the titanium alloy ingot within the ceramic crucible utilizing induction heating generated by an induction coil positioned around the ceramic crucible. The method also includes evacuating the internal chamber to create an evacuated internal chamber having a pressure no greater than 3×10⁻² atmosphere. The method also includes transferring the completely melted titanium alloy material into the mold from the crucible using a pressure differential created between the external chamber and the internal chamber. A high pressure differential in maintained between the external chamber and the internal chamber during the melting of the titanium alloy ingot. The pressure of the internal chamber and the pressure of the external chamber are monitored and communicated to the PLC during the casting process, and wherein the PLC controls the casting process based on the pressure of the internal chamber and the pressure of the external chamber.

Yet another aspect of the present invention is a method for unit cell casting of titanium or titanium-alloys. The method includes positioning a mold within an internal chamber of a casting chamber. The method also includes evacuating an external chamber to create an evacuated external chamber wherein a ceramic crucible containing a titanium alloy ingot is positioned therein. The method also includes injecting a pressurized gas into the evacuated external chamber to create a pressurized external chamber with a pressure in excess of 1 atmosphere. The method also includes melting the titanium alloy ingot within the ceramic crucible utilizing induction heating generated by an induction coil positioned around the ceramic crucible. The method also includes evacuating the internal chamber to create an evacuated internal chamber having a pressure no greater than 3×10⁻² atmosphere. The method also includes utilizing a high pressure differential between the external chamber and the internal chamber to flow the completely melted titanium alloy material into the mold from the crucible.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is an illustration of a unit-cell casting system.

FIG. 2 is an isolated view of an interior chamber, crucible, induction coils and mold of the unit-cell casting system, showing placement of the induction coils at a lower section of the crucible.

FIG. 2A is an isolated view of an interior chamber, crucible, induction coils and mold of the unit-cell casting system, showing placement of the induction coils at an upper section of the crucible.

FIG. 2B is an isolated view of an interior chamber, crucible, induction coils and mold of the unit-cell casting system, showing an insulation material wrapped around the mold.

FIG. 3A is an illustration of a technician pre-heating a mold in an oven.

FIG. 3B is an illustration of a technician attaching the pre-heated mold to a lid of the internal container.

FIG. 3C is an illustration of a technician attaching the lid to the internal container.

FIG. 3D is an isolated view of the internal container.

FIG. 3E is an isolated view of the lid of the internal container.

FIG. 3F is an isolated view of the internal chamber of the internal container showing infrared heaters.

FIG. 4 is an illustration of a unit-cell casting system during an external chamber evacuation step.

FIG. 4A is an illustration of a unit-cell casting system during an external chamber pressurization step.

FIG. 4B is an illustration of a unit-cell casting system during an ingot melting step.

FIG. 5 is an illustration of a PLC unit and computer for a unit cell casting system.

FIG. 6 is a block diagram of a unit cell casting method.

FIG. 7 is an isolated view of a crucible for a unit cell casting system.

FIG. 8 is a flow chart of a method for unit cell titanium casting.

FIG. 9 is a flow chart of a method for unit cell titanium casting.

FIG. 10 is a flow chart of a method for unit cell titanium casting.

FIG. 11 is a flow chart of a method for unit cell titanium casting.

FIG. 12 is an illustration of a PLC unit, an operator's computer for a unit cell casting system, an internal chamber with monitoring connections.

FIG. 13 is an illustration of a PLC unit, an operator's computer for a unit cell casting system, an internal chamber with monitoring connections.

### DETAILED DESCRIPTION OF THE INVENTION

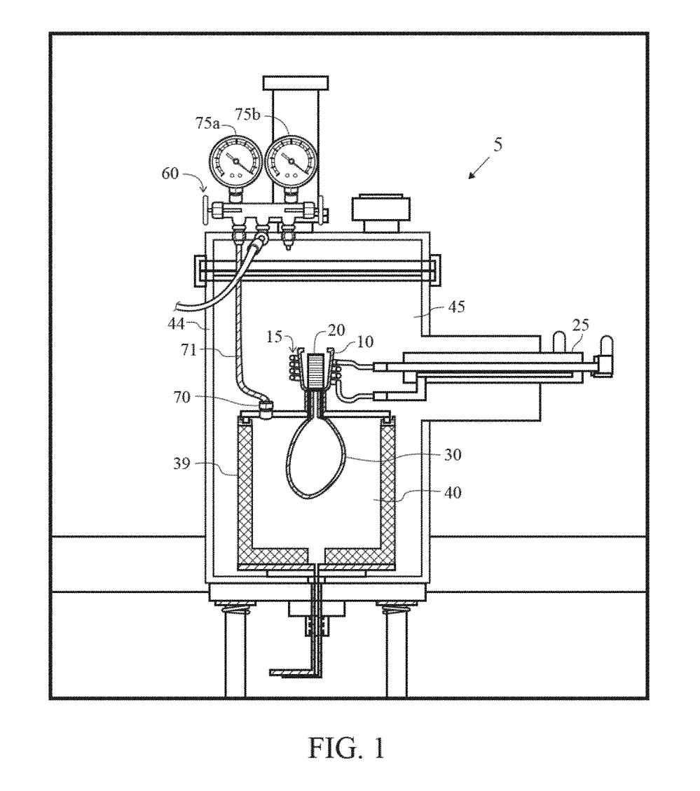

As shown in FIG. 1, a unit cell titanium casting system 5 comprises an external container 44, an internal container 39, a vacuum mechanism 60, a crucible 10, an induction coil 15, a coil electrical generation mechanism 25, and a mold 30. The external container 44 defines an external chamber 45. The internal container 39 defines an internal chamber 40. The vacuum mechanism 60 includes a vacuum line 71, a vacuum connector 70 and pressure gauges 75a and 75b. The vacuum mechanism 60 is utilized to evacuate and pressurize the external chamber 45 and the internal chamber 40 in order to create a pressure differential between the internal chamber 40 and the external chamber 45.

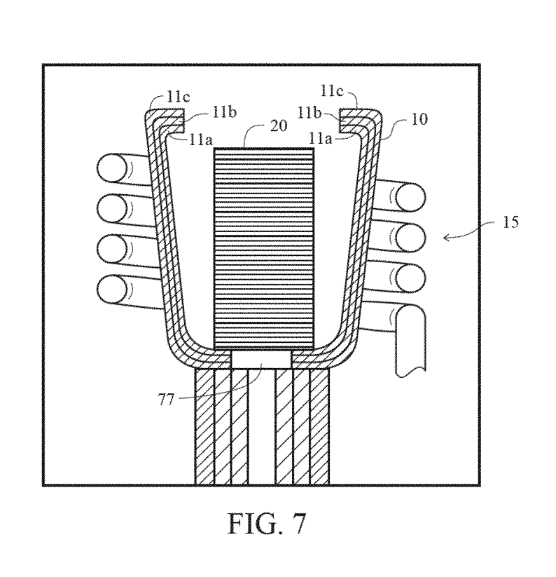

The crucible 10 is preferably composed of a ceramic material. In a most preferred embodiment, the crucible 10 is composed of a first layer 11a, a second layer 11b and a silica based third layer 11c, as shown in FIG. 7. A metal ingot 20 is placed within the interior of the crucible 10. The metal ingot 20 is preferably a titanium alloy material. The volume of the crucible 10 preferably corresponds to the amount of metal necessary for forming the article. The interior of the crucible 10 preferably has a diameter ranging from 15 centimeters (“cm”) to 90 cm, more preferably from 35 cm to 60 cm. A height of the crucible 10 preferably ranges 30 cm to 200 cm, and more preferably from 60 cm to 100 cm.

A connection nozzle 27 is connected between a bottom opening (not shown) of the crucible 10 and an opening to the mold 30. The connection nozzle 27 allows the melted metal material from the ingot 20 to flow into the mold 30 for casting of the article. Specifically, the size of connection nozzle 27 is determined based on the size and shape of the cavity of the mold 30, and is preferably from 5 cm to 100 cm, and more preferably from 15 cm to 50 cm.

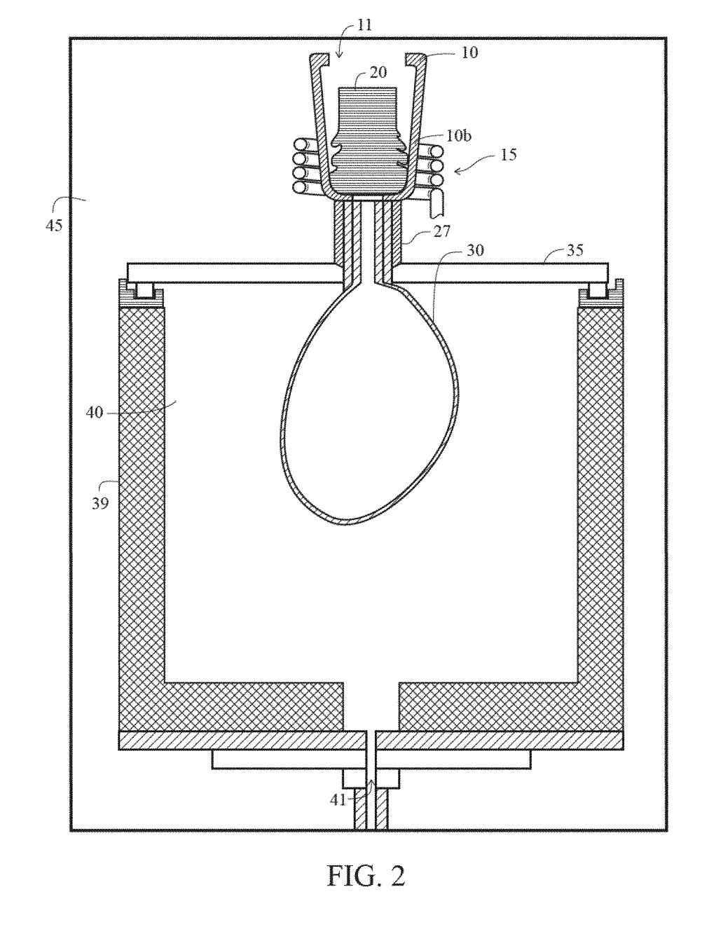

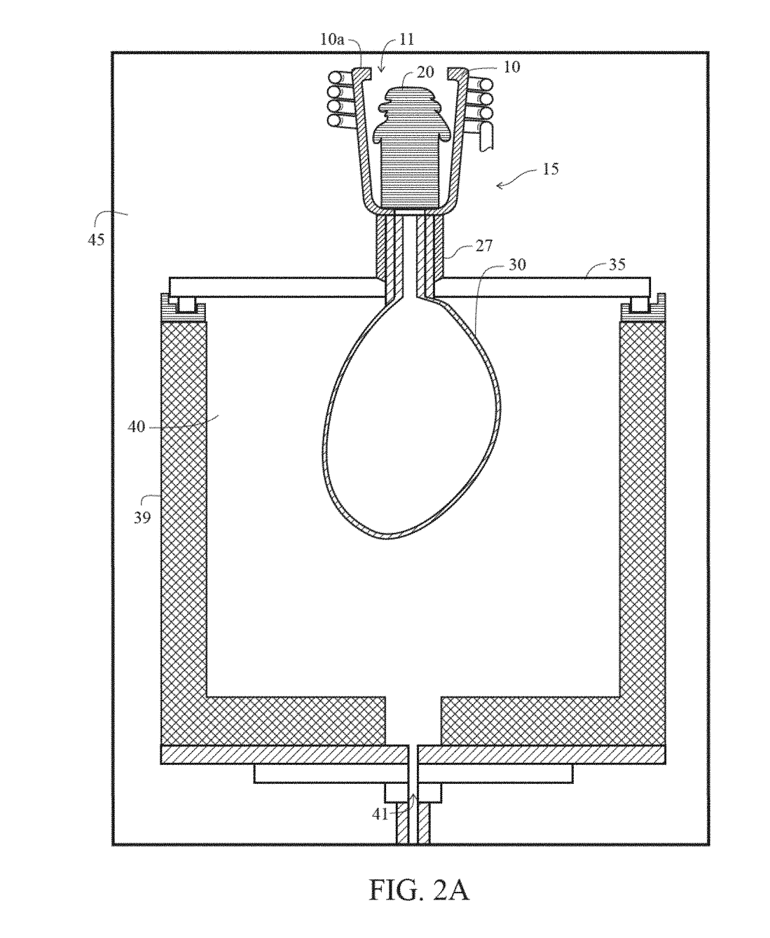

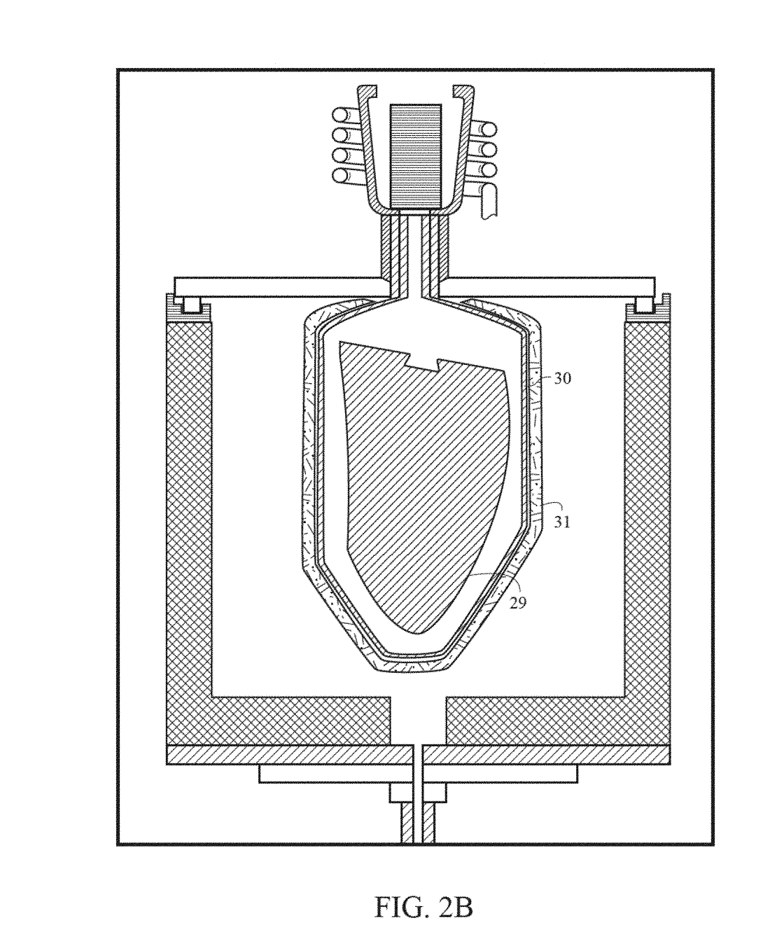

The induction coil 15 is wrapped around the crucible 10. The induction coil 15 is energized to generate an electromagnetic force to melt the metal ingot 20 (e.g., titanium alloy ingot) within the crucible 10. The coil electrical generation mechanism 25 provides the electricity to the induction coil 15. As shown in FIG. 2, the induction coil 15 is wrapped around a bottom section 10b of the crucible 10. This melts the bottom of the ingot 20 first. As shown in FIG. 2A, the induction coil 15 is wrapped around an upper section 10a of the crucible 10. This melts the top of the ingot 20 first.

In order to optimize the ability of the target material to seal around the port of a ceramic crucible 10, the induction coil 15 is preferably centered on the upper third of the ingot 20. This positioning allows the induction coil 15 to first act on the upper portion of the ingot 20 (melting the material from the top down), causing molten material to cascade around the still-solid ingot 20 and forming a seal before the electromagnetic forces of the induction coil 15 affect the remaining material.

Alternatively, in order to fully utilize the electromagnetic forces of the induction coil 15, to include the electromagnetic stirring of the melt, the induction coil 15 is positioned towards the bottom 10b of the ceramic crucible 10. This positioning allows for a uniform melt as molten material cascades onto itself and also increased homogeneity of the pour as the electromagnetic forces can better act on the molten material prior to it being evacuated from the crucible 10.

Melting of the ingot 20 of titanium alloy is carried out in a vacuum condition for induction melting. The induction coil 15 is connected to the coil electrical generation mechanism 25.

The ceramic crucible 10 is utilized for vacuum induction melting of the titanium alloy. The ceramic material does not interfere with the fielding effect of the electromagnetic force, and the electro-magnetic induction energy generated by the induction coil 15 is fully focused on melting the ingot of titanium alloy.

In an embodiment shown in FIG. 2B, an insulating material 31 is wrapped around the mold 30. During casting pattern molds are preheated prior to use in order to improve the flow of material into the mold itself and to better allow the mold 30 to fill completely. Due to the nature of titanium materials, and the melting process itself, the more that heat loss is minimized, the greater time the material has to flow and fill the mold 30 prior to solidification. To this end, pattern mold heat is retained through the use of an insulating material 31 (e.g.: Kaolin wool) thereby extending the useful period of the mold 30 prior to the pour and allowing for better fill, including filling of more difficult molds (e.g., thin walled castings).

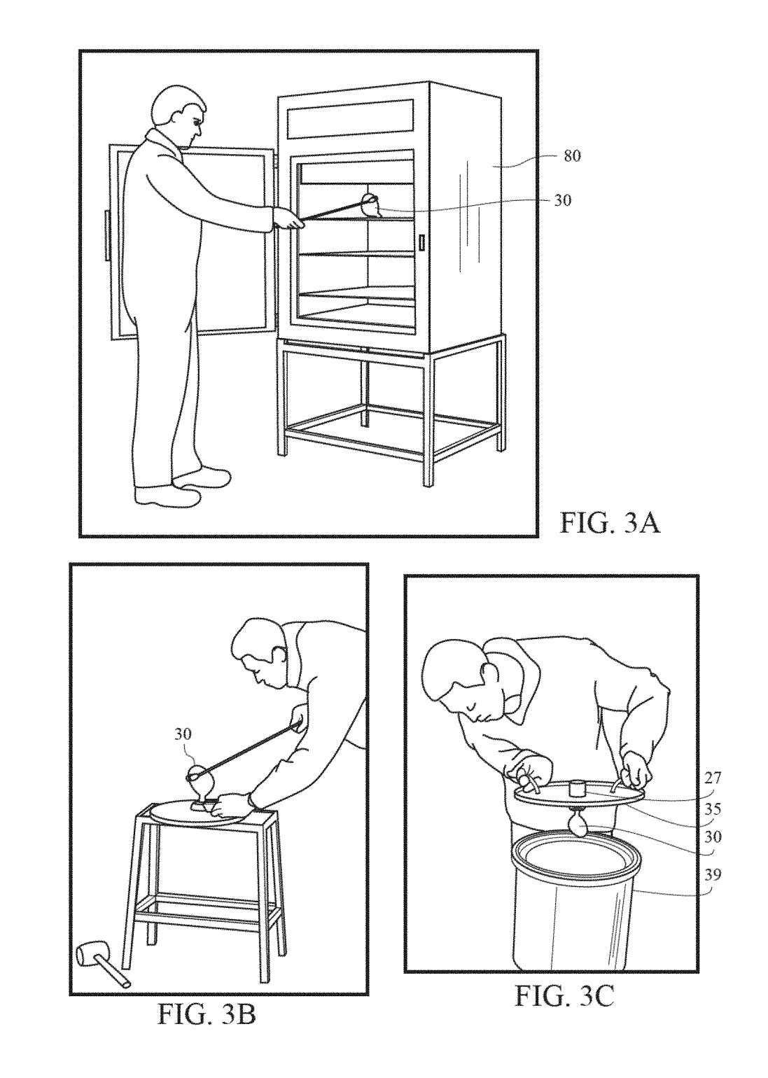

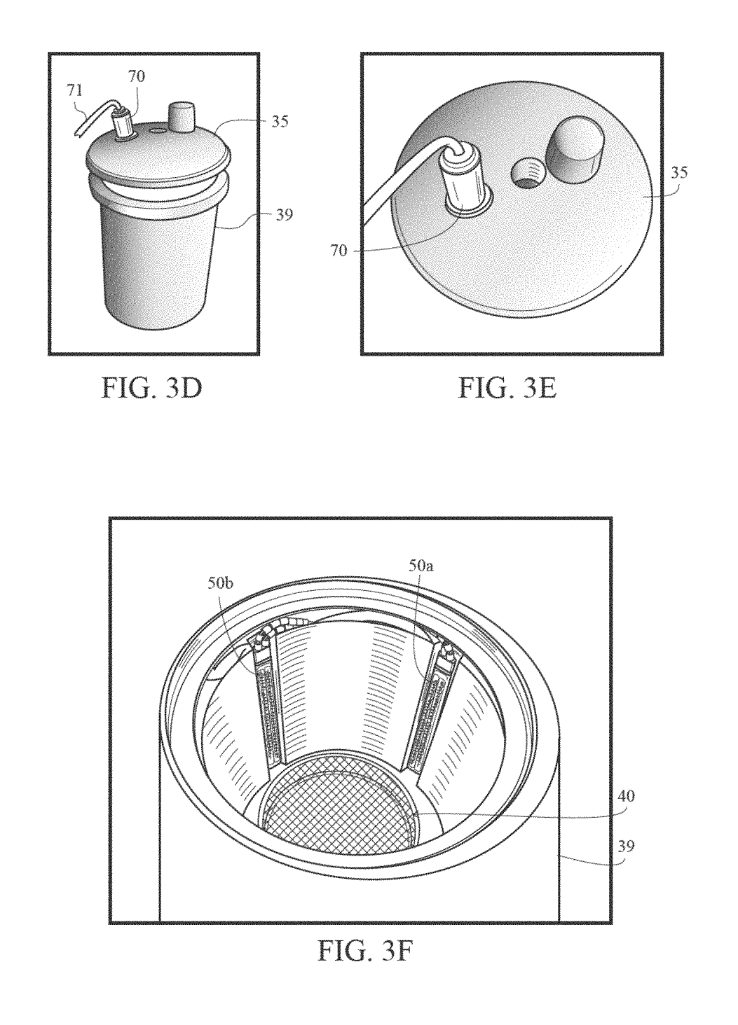

As shown in FIGS. 3A, 3B, 3C, 3D and 3E, the mold 30 is preheated in an oven 80. During unit cell casting, pattern molds 30 are preheated prior to use in order to improve the flow of material into the mold 30 itself and to better allow the mold 30 to fill completely. Due to the nature of titanium materials, and the melting process itself, there is a likely correlation between the temperature of the mold 30 and the ability to fill complex and/or thin walled pattern molds 30. Temperatures testing include 1050° C., 1060° C., 1100° C., 1150° C., 1200° C., 1250° C. and 1260° C. The pre-heated mold is removed from the 80 and attached to a lid 35 of the internal container 39.

In an alternative embodiment shown in FIG. 3F, infrared heaters 50a and 50b are used to maintain the heat of the mold 30 within the internal chamber 40. Due to the nature of titanium materials, and the melting process itself, the more that heat loss is minimized, the greater time the material can flow and fill the mold 30 prior to solidification. To this end, pattern mold heat is retained through the use of infrared heaters 50a and 50b placed within the internal walls of the internal chamber 40 of the internal container 39 in order to minimize pattern mold cool down and improve the ability to cast complex and/or thin-walled parts.

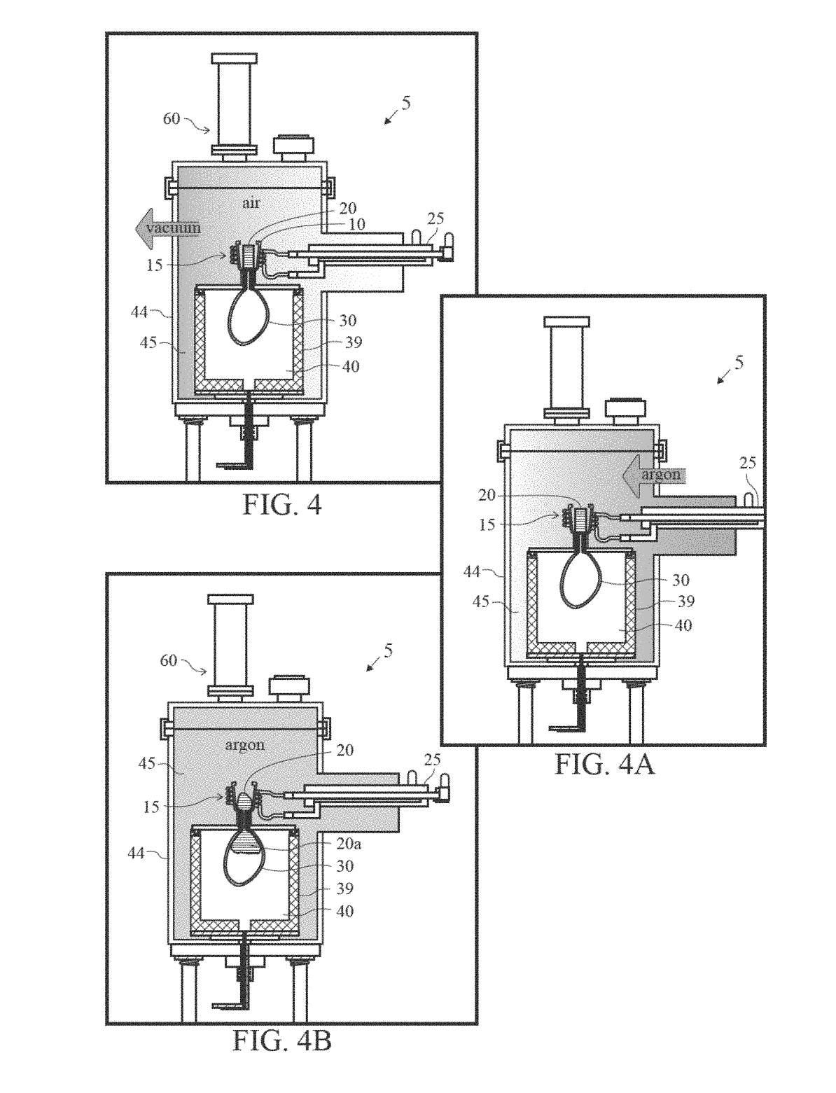

FIGS. 4, 4A and 4B illustrate the casting process using a pressure differential between the external chamber 45 and the internal chamber 40 to assist in the flow of melted titanium alloy materials into a mold 30.

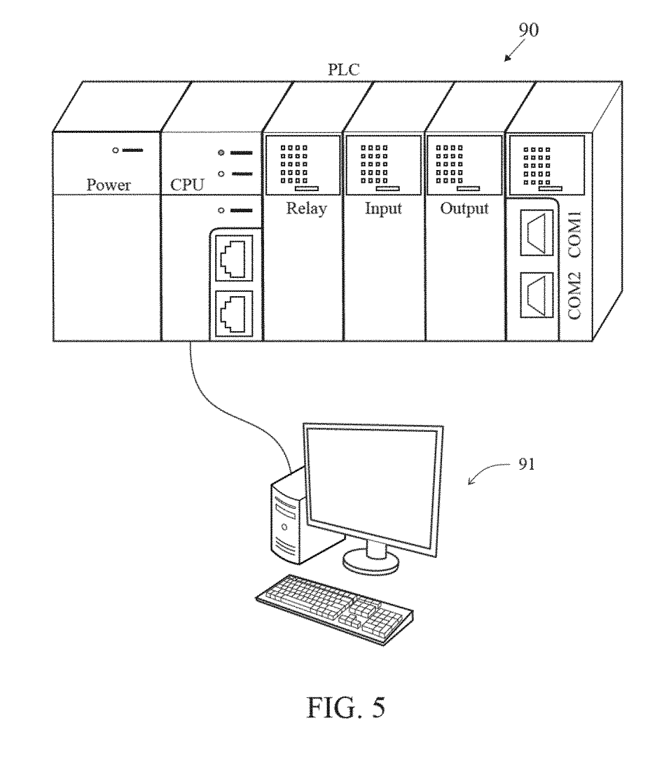

FIG. 5 illustrates a programmable logic computer (“PLC”) and operator computer 91 utilized with the unit cell casting system 5.

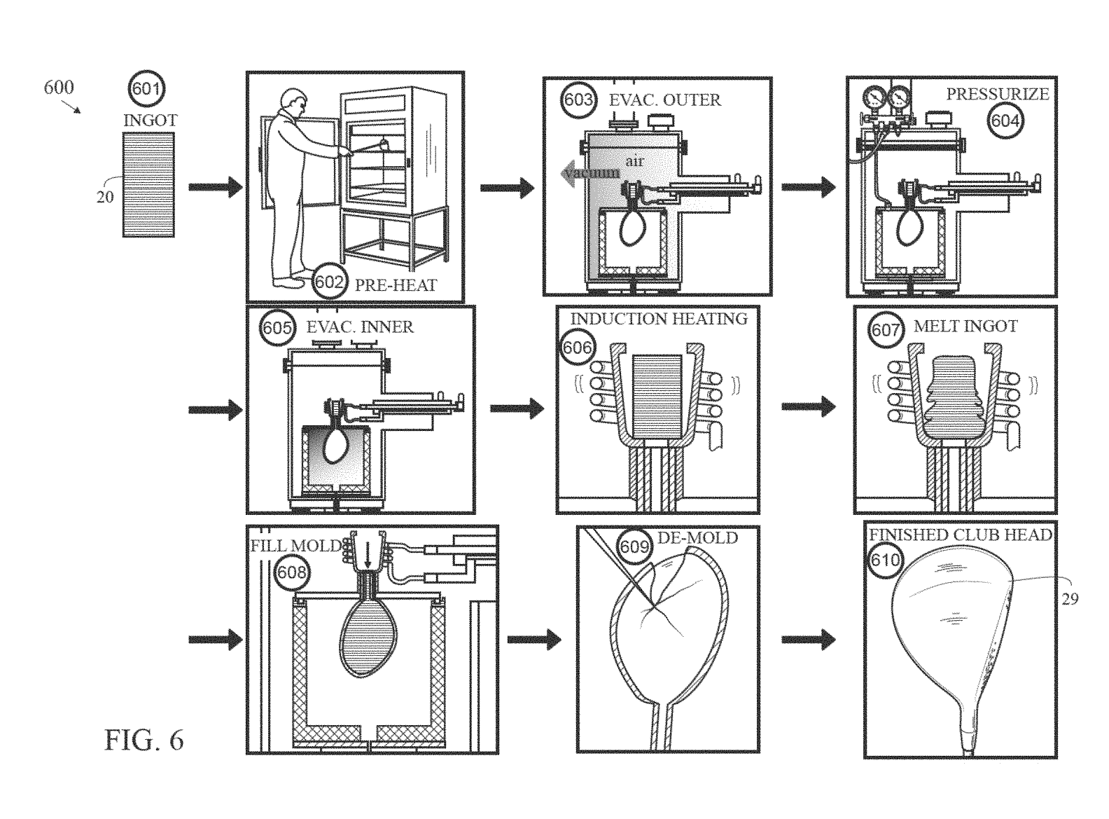

FIG. 6 is a block diagram of a unit cell casting method 600. At step 601, an ingot 20 is prepared for casting. The single ingot 20 is utilized to manufacture a single article such as a golf club head 29. As opposed to manufacturing multiple articles in a single process, which results in the loss of material, the present invention manufactures only a single article in each process. At step 602, the mold 30 is preheated in an oven. At step 603, the external chamber 45 is evacuated. At step 604, the external chamber 45 is pressurized with an argon gas. At step 605, the internal chamber 40 is evacuated. At step 606, the induction coil 15 is energized and at step 607 the ingot 20 is melted within the crucible 10. At the step 608, the melted material flows into mold 30. At step 609, the de-molding process occurs. At step 610, the article (golf club head) 29 is finished. A frequency generated in the induction coil ranges from 1 kilo-Hertz to 50 kilo-Hertz, and a power ranges from 15 kilo-Watts to 50 kilo-Watts. An atmospheric pressure of the evacuated internal chamber ranges from 3×10⁻² atmosphere to 9.87×10⁻⁷ atmosphere. An atmospheric pressure of the evacuated internal chamber ranges from 9.87×10⁻⁷ atmosphere to 9.87×10⁻¹³ atmosphere.

As shown in FIG. 7, the first layer 11a and the second layer 11b are preferably composed of yttrium oxide and other materials. Yttrium oxide is highly inert to titanium in a high-temperature environment resulting in no chemical reaction between the two materials. Yttrium oxide also isolates the ceramic material from the titanium during the melting process to prevent reaction between them to ensure the smooth melting of the titanium-alloy. The third layer 11c of the crucible 10 is preferably composed of silicon dioxide and other materials. The silicon dioxide resists the metallic expansion and thermal stress during the melting process to ensure strength of the crucible.

A preferred thickness of the first layer 11a is from 0.5 mm to 1.5 mm and the preferred thickness range of the crucible 10 is from 5 mm to 15 mm.

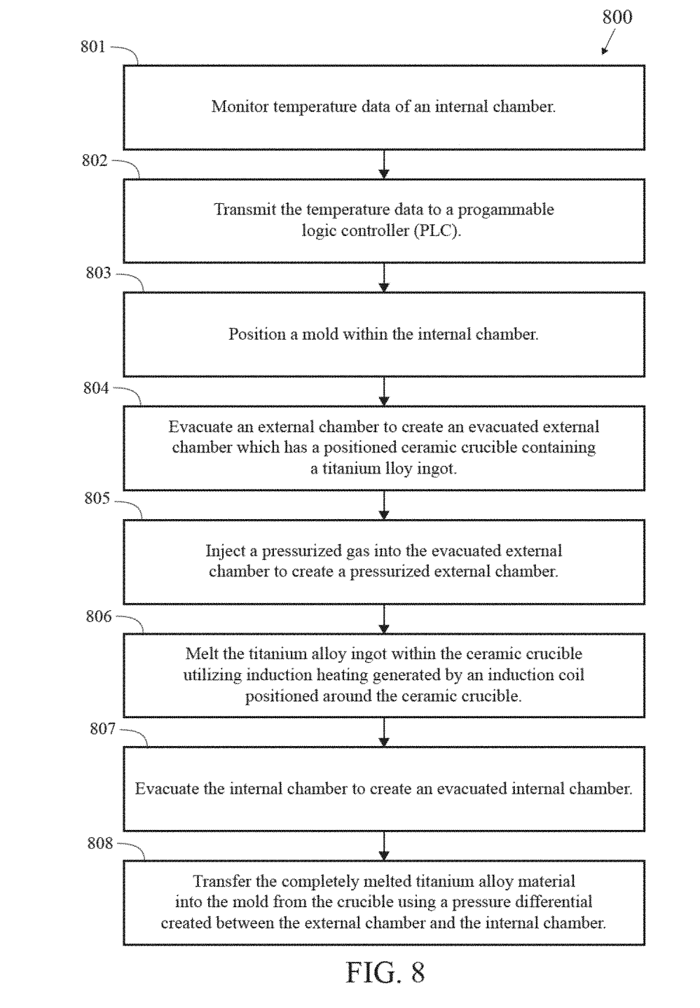

A method 800 for unit cell casting of titanium or titanium-alloys is shown in FIG. 8. At block 801, temperature data of an internal chamber is monitored using an optical pyrometer. At block 802, the temperature data is transmitted from the optical pyrometer to a programmable logic controller (PLC). At block 803, a mold is positioned within the internal chamber. At block 804, an external chamber is evacuated to create an evacuated external chamber wherein a ceramic crucible containing a titanium alloy ingot is positioned therein. At block 805, a pressurized gas is injected into the evacuated external chamber to create a pressurized external chamber. At block 806, the titanium alloy ingot is melted within the ceramic crucible utilizing induction heating generated by an induction coil positioned around the ceramic crucible. At block 807, the internal chamber is evacuated to create an evacuated internal chamber, wherein a mold is positioned within the internal chamber. At block 808, the completely melted titanium alloy material is transferred into the mold from the crucible using a pressure differential created between the external chamber and the internal chamber.

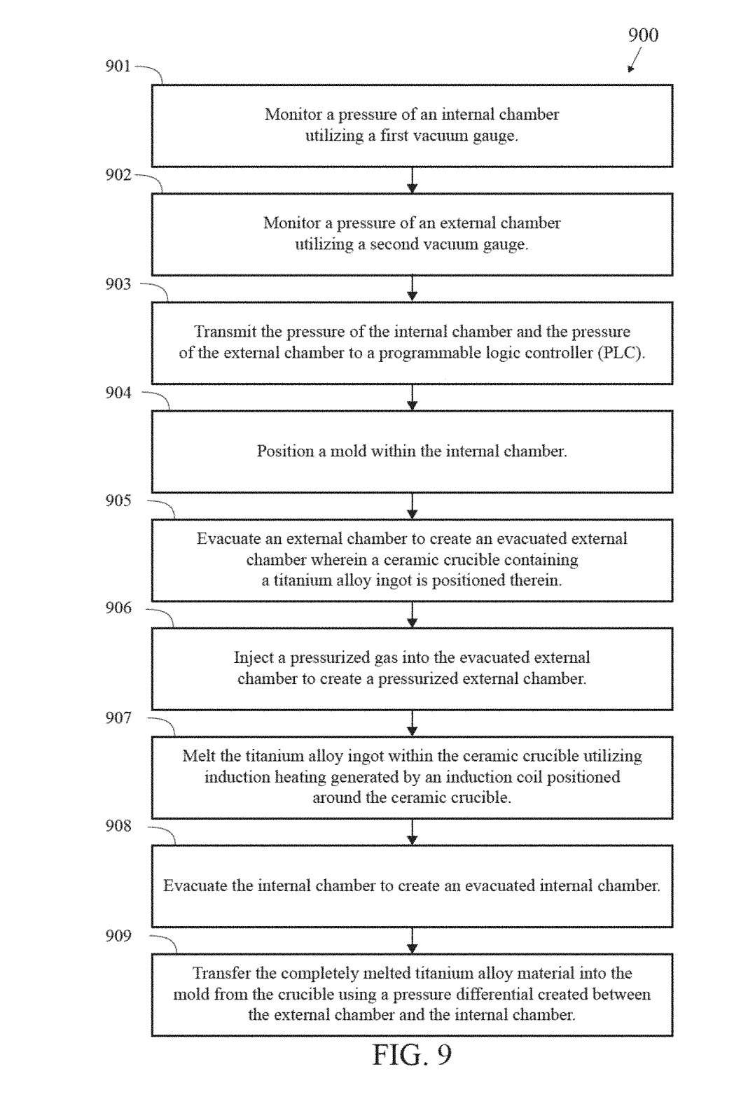

A method 900 for unit cell casting of titanium or titanium-alloys is shown in FIG. 9. At block 901, a pressure of an internal chamber is monitored utilizing a first vacuum gauge. At block 902, a pressure of an external chamber is monitored utilizing a second vacuum gauge. At block 903, the pressure of the internal chamber and the pressure of the external chamber are transmitted to a programmable logic controller (PLC). At block 904, a mold is positioned within the internal chamber. At block 905, an external chamber is evacuated to create an evacuated external chamber wherein a ceramic crucible containing a titanium alloy ingot is positioned therein. At block 906, a pressurized gas is injected into the evacuated external chamber to create a pressurized external chamber. At block 907, the titanium alloy ingot is melted within the ceramic crucible utilizing induction heating generated by an induction coil positioned around the ceramic crucible. At block 908, the internal chamber is evacuated to create an evacuated internal chamber. At block 909, the completely melted titanium alloy material is transferred into the mold from the crucible using a pressure differential created between the external chamber and the internal chamber.

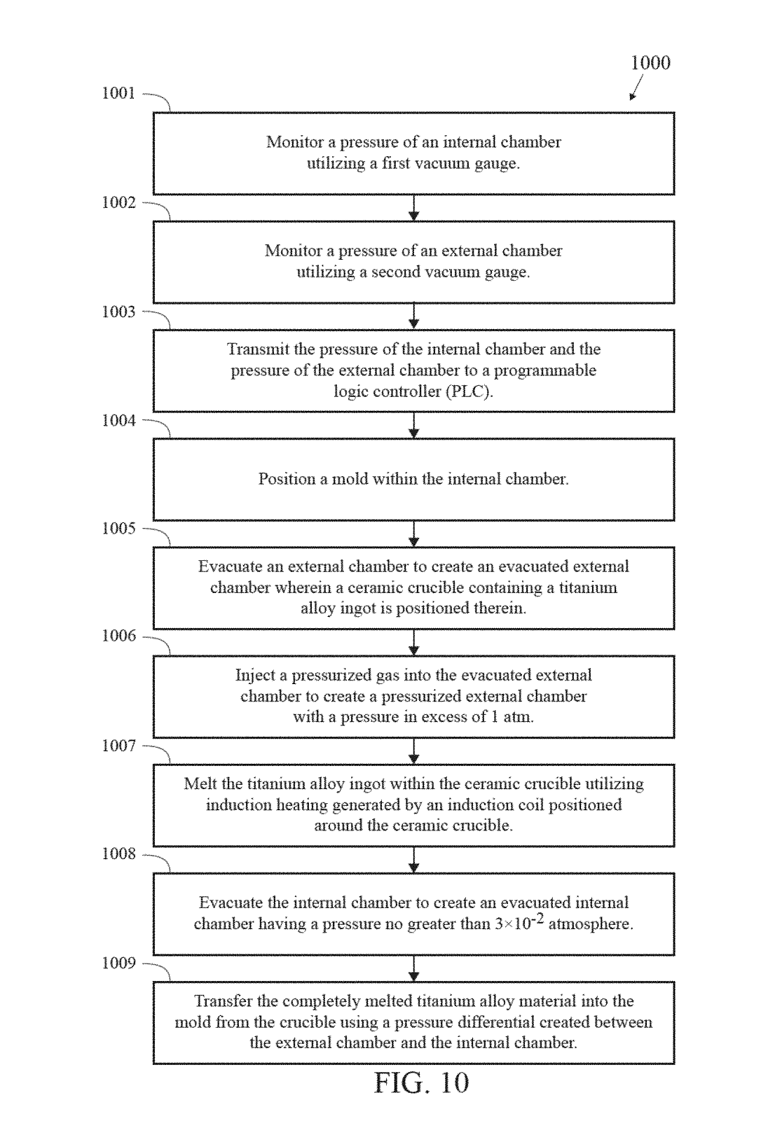

A method 1000 for unit cell casting of titanium or titanium-alloys is shown in FIG. 10. At block 1001, a pressure of an internal chamber is monitored utilizing a first vacuum gauge. At block 1002, a pressure of an external chamber is monitored utilizing a second vacuum gauge. At block 1003, the pressure of the internal chamber and the pressure of the external chamber are transmitted to a programmable logic controller (PLC). At block 1004, a mold is positioned within the internal chamber. At block 1005, an external chamber is evacuated to create an evacuated external chamber wherein a ceramic crucible containing a titanium alloy ingot is positioned therein. At block 1006, a pressurized gas is injected into the evacuated external chamber to create a pressurized external chamber. At block 1007, the titanium alloy ingot is melted within the ceramic crucible utilizing induction heating generated by an induction coil positioned around the ceramic crucible. At block 1008, the internal chamber is evacuated to create an evacuated internal chamber having a pressure no greater than 3×10⁻² atmosphere. At block 1009, the completely melted titanium alloy material is transferred into the mold from the crucible using a pressure differential created between the external chamber and the internal chamber.

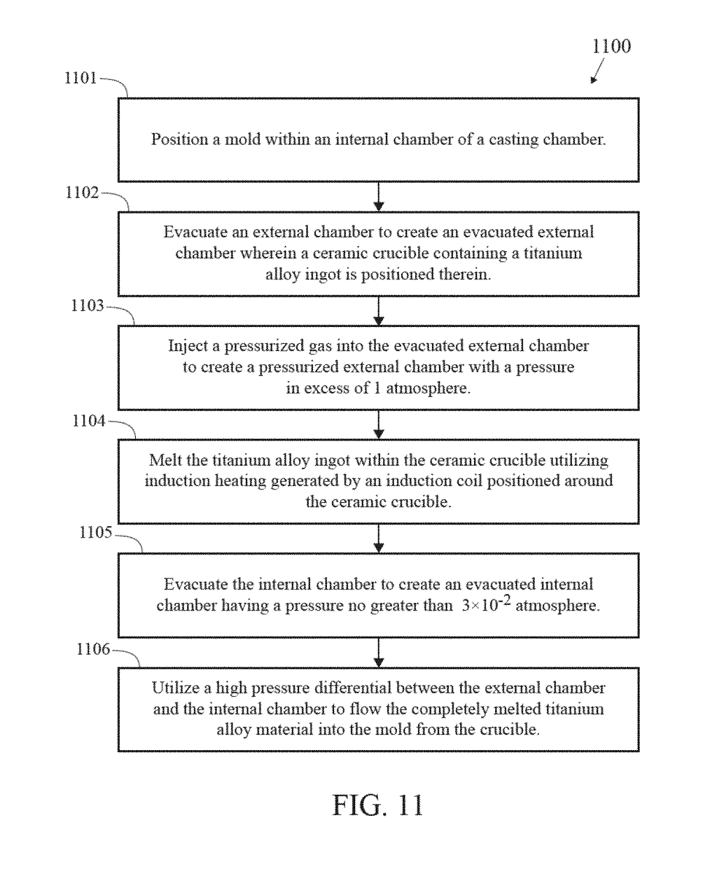

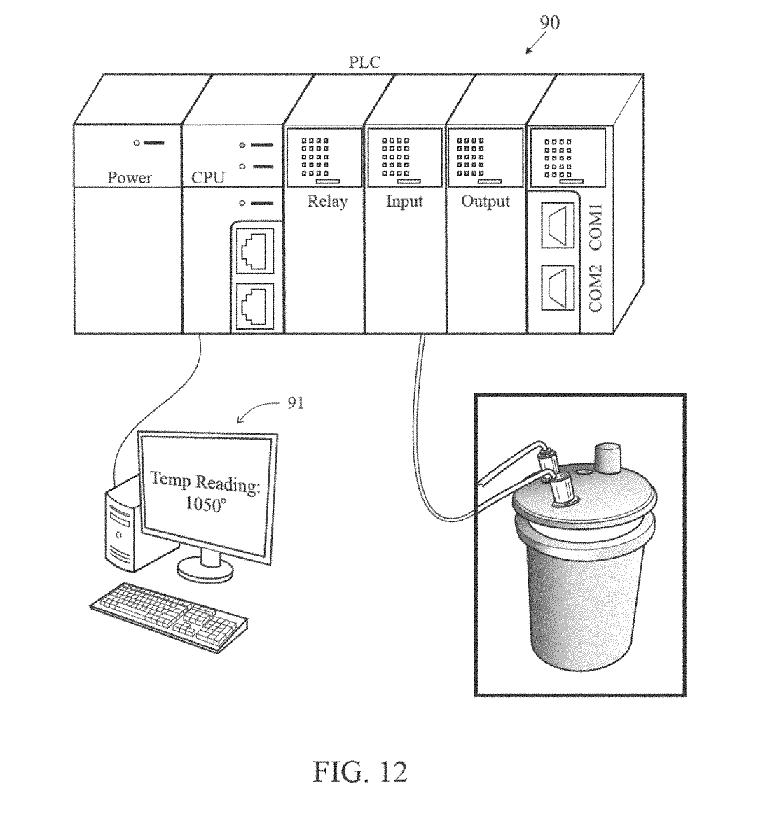

A method 1100 for unit cell casting of titanium or titanium-alloys is shown in FIG. 11. At block 1101, a mold is positioned within an internal chamber of a casting chamber. At block 1102, an external chamber is evacuated to create an evacuated external chamber wherein a ceramic crucible containing a titanium alloy ingot is positioned therein. At block 1103, a pressurized gas is injected into the evacuated external chamber to create a pressurized external chamber with a pressure in excess of 1 atmosphere. At block 1104, the titanium alloy ingot is melted within the ceramic crucible utilizing induction heating generated by an induction coil positioned around the ceramic crucible. At block 1105, the internal chamber is evacuated to create an evacuated internal chamber having a pressure no greater than 3×10⁻² atmosphere. At block 1106, a high pressure differential is utilized between the external chamber and the internal chamber to flow the completely melted titanium alloy material into the mold from the crucible.

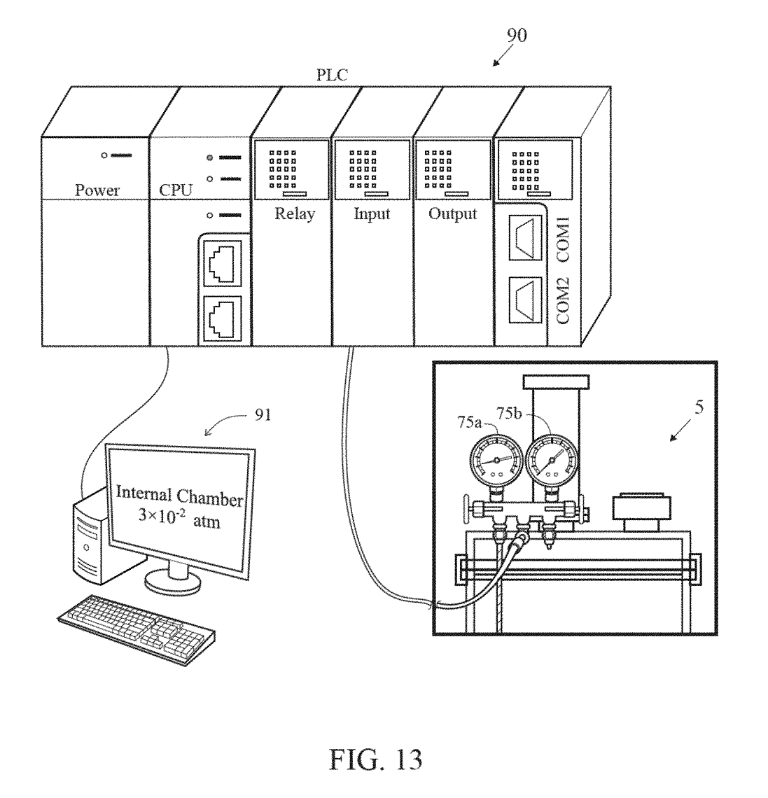

FIG. 13 illustrates a PLC 90, an operator's computer 91 and an apparatus 5 for a system for unit cell titanium casting.

FIG. 14 illustrates a PLC 90, an operator's computer 91 and an internal chamber with an optical pyrometer for a system for unit cell titanium casting. The optical pyrometer monitors the temperature of the internal chamber.

Those skilled in the pertinent art will recognize that materials other than titanium and titanium alloy may be cast in the unit cell casting system without departing from the scope and spirit of the present invention.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention the following:

1. A method for unit cell casting of titanium or titanium-alloys, the method comprising:
monitoring temperature data of an internal chamber;
transmitting the temperature data to a programmable logic controller (PLC);
positioning a mold within the internal chamber;
evacuating an external chamber to create an evacuated external chamber wherein a ceramic crucible containing a titanium alloy ingot is positioned therein;
injecting a pressurized gas into the evacuated external chamber to create a pressurized external chamber;
melting the titanium alloy ingot within the ceramic crucible utilizing induction heating generated by an induction coil positioned around the ceramic crucible;
evacuating the internal chamber to create an evacuated internal chamber;
transferring the completely melted titanium alloy material into the mold from the crucible using a pressure differential created between the external chamber and the internal chamber;
wherein the temperature of the internal chamber is monitored and communicated to the PLC during the casting process, and wherein the PLC controls the temperature of the internal chamber and the heat generated by the induction coil.

2. The method according to claim 1 wherein the pressurized gas is argon.

3. The method according to claim 1 wherein a frequency generated in the induction coil ranges from 1 kilo-Hertz to 50 kilo-Hertz, and a power ranges from 15 kilo-Watts to 50 kilo-Watts.

4. The method according to claim 1 wherein an atmospheric pressure of the evacuated internal chamber ranges from 3×10⁻² atmosphere to 9.87×10⁻⁷ atmosphere.

5. The method according to claim 1 wherein the mold is for a thin-walled golf club head.

6. The method according to claim 1 wherein the internal chamber is preheated at a temperature ranging from 1150° C. to 1250° C.

7. The method according to claim 1 wherein the temperature is monitored using an optical pyrometer positioned within the internal chamber.

8. The method according to claim 7 wherein temperature data is communicated from the optical pyrometer to the PLC.

9. The method according to claim 1 wherein an atmospheric pressure of the evacuated internal chamber ranges from 9.87×10⁻⁷ atmosphere to 9.87×10⁻¹³ atmosphere.

10. A system for unit cell casting of titanium or titanium-alloys, the system comprising:
an external chamber;
a ceramic crucible positioned within the external chamber;
an induction coil positioned around the ceramic crucible;
an internal chamber positioned within the external chamber; and
a mold positioned within the internal chamber;
an optical pyrometer positioned within the internal chamber;
a PLC;
wherein the temperature of the internal chamber is monitored and communicated to the PLC during the casting process, and wherein the PLC controls the temperature of the internal chamber and the heat generated by the induction coil;
wherein the external chamber is evacuated to create an evacuated external chamber wherein the ceramic crucible contains a titanium alloy ingot positioned therein;
wherein a pressurized gas is injected into the evacuated external chamber to create a pressurized external chamber;
wherein the titanium alloy ingot is melted within the ceramic crucible utilizing induction heating generated by the induction coil positioned around the ceramic crucible;
wherein the internal chamber is evacuated to create an evacuated internal chamber;
wherein the titanium alloy material is completely transferred into the mold from the crucible using a pressure differential created between the external chamber and the internal chamber.

11. A method for unit cell casting of titanium or titanium-alloys, the method comprising:
monitoring a pressure of an internal chamber utilizing a first vacuum gauge;
monitoring a pressure of an external chamber utilizing a second vacuum gauge;
transmitting the pressure of the internal chamber and the pressure of the external chamber to a programmable logic controller (PLC);
positioning a mold within the internal chamber;
evacuating an external chamber to create an evacuated external chamber wherein a ceramic crucible containing a titanium alloy ingot is positioned therein;
injecting a pressurized gas into the evacuated external chamber to create a pressurized external chamber;
melting the titanium alloy ingot within the ceramic crucible utilizing induction heating generated by an induction coil positioned around the ceramic crucible;
evacuating the internal chamber to create an evacuated internal chamber;
transferring the completely melted titanium alloy material into the mold from the crucible using a pressure differential created between the external chamber and the internal chamber;
wherein the pressure of the internal chamber and the pressure of the external chamber are monitored and communicated to the PLC during the casting process, and wherein the PLC controls the casting process based on the pressure of the internal chamber and the pressure of the external chamber.

12. The method according to claim 11 wherein a frequency generated in the induction coil ranges from 1 kilo-Hertz to 50 kilo-Hertz, and a power ranges from 15 kilo-Watts to 50 kilo-Watts.

13. The method according to claim 11 wherein an atmospheric pressure of the evacuated internal chamber ranges from 3×10⁻² atmosphere to 9.87×10⁻⁷ atmosphere.

14. The method according to claim 11 wherein the PLC determines when to melt the titanium alloy based on the pressures of the internal chamber and the external chamber.

15. The method according to claim 14 wherein the PLC determines when to change the pressure of internal chamber and the external chamber.

16. The method according to claim 11 wherein an atmospheric pressure of the evacuated internal chamber ranges from 9.87×10⁻⁷ atmosphere to 9.87×10⁻¹³ atmosphere.

17. A system method for unit cell casting, the system comprising:
an external chamber;
a ceramic crucible positioned within the external chamber;
an induction coil positioned around a bottom section of the ceramic crucible;
an internal chamber positioned within the external chamber; and
a mold positioned within the internal chamber;
a first vacuum gauge positioned within the internal chamber;
a second vacuum gauge positioned within the external chamber;
a PLC in communication with the first vacuum gauge, the second vacuum gauge, and the induction coil;
wherein the pressure of the internal chamber and the pressure of the external chamber are monitored and communicated to the PLC during the casting process, and wherein the PLC controls the casting process based on the pressure of the internal chamber and the pressure of the external chamber;
wherein the external chamber is evacuated to create an evacuated external chamber wherein the ceramic crucible contains an ingot positioned therein;
wherein a pressurized gas is injected into the evacuated external chamber to create a pressurized external chamber;
wherein the ingot is melted within the ceramic crucible utilizing induction heating generated by the induction coil positioned around the ceramic crucible;
wherein the internal chamber is evacuated to create an evacuated internal chamber;
wherein the ingot material is completely transferred into the mold from the crucible using a pressure differential created between the external chamber and the internal chamber.

18. A method for unit cell casting of titanium or titanium-alloys, the method comprising:
monitoring a pressure of an internal chamber utilizing a first vacuum gauge;
monitoring a pressure of an external chamber utilizing a second vacuum gauge;
transmitting the pressure of the internal chamber and the pressure of the external chamber to a programmable logic controller (PLC);
positioning a mold within the internal chamber;
evacuating an external chamber to create an evacuated external chamber wherein a ceramic crucible containing a titanium alloy ingot is positioned therein;
injecting a pressurized gas into the evacuated external chamber to create a pressurized external chamber with a pressure in excess of 1 atm;
melting the titanium alloy ingot within the ceramic crucible utilizing induction heating generated by an induction coil positioned around the ceramic crucible;
evacuating the internal chamber to create an evacuated internal chamber having a pressure no greater than 3×10⁻² atmosphere;
transferring the completely melted titanium alloy material into the mold from the crucible using a pressure differential created between the external chamber and the internal chamber;
wherein a high pressure differential in maintained between the external chamber and the internal chamber during the melting of the titanium alloy ingot;
wherein the pressure of the internal chamber and the pressure of the external chamber are monitored and communicated to the PLC during the casting process, and wherein the PLC controls the casting process based on the pressure of the internal chamber and the pressure of the external chamber.

19. The method according to claim 18 wherein a frequency generated in the induction coil ranges from 1 kilo-Hertz to 50 kilo-Hertz, and a power ranges from 15 kilo-Watts to 50 kilo-Watts.

20. The method according to claim 18 wherein an atmospheric pressure of the evacuated internal chamber ranges from 3×10⁻² atmosphere to 9.87×10⁻⁷ atmosphere.

21. The method according to claim 18 wherein the PLC determines when to melt the titanium alloy based on the pressures of the internal chamber and the external chamber.

22. The method according to claim 21 wherein the PLC determines when to change the pressure of internal chamber and the external chamber.

23. The method according to claim 18 wherein an atmospheric pressure of the evacuated internal chamber ranges from 9.87×10⁻⁷ atmosphere to 9.87×10⁻¹³ atmosphere.

24. A method for unit cell casting, the method comprising:
positioning a mold within an internal chamber of a casting chamber;
evacuating an external chamber to create an evacuated external chamber wherein a ceramic crucible containing an ingot is positioned therein;
injecting a pressurized gas into the evacuated external chamber to create a pressurized external chamber with a pressure in excess of 1 atmosphere;
melting the ingot within the ceramic crucible utilizing induction heating generated by an induction coil positioned around the ceramic crucible;
evacuating the internal chamber to create an evacuated internal chamber having a pressure no greater than 3×10⁻² atmosphere; and
utilizing a high pressure differential between the external chamber and the internal chamber to flow the completely melted ingot material into the mold from the crucible.

25. The method according to claim 24 wherein a PLC determines when to melt the titanium alloy based on the pressures of the internal chamber and the external chamber.

26. The method according to claim 25 wherein the PLC determines when to change the pressure of internal chamber and the external chamber.

27. The method according to claim 24 wherein an atmospheric pressure of the evacuated internal chamber ranges from 9.87×10⁻⁷ atmosphere to 9.87×10⁻¹³ atmosphere.
